(19) United States
(12) Patent Application Publication
(10) Pub. No.: US 2010/0076918 A1
(43) Pub. Date: Mar. 25, 2010

(54) APPARATUS AND METHOD FOR PERFORMING SERVICE ADAPTATION IN RESPECT OF A MOBILE COMPUTING DEVICE

(75) Inventors: Abdelhak Attou, Guildford (GB); Klaus Moessner, Guilford (GB)

Correspondence Address: PARK, VAUGHAN & FLEMING LLP, 2820 FIFTH STREET, DAVIS, CA, 95618-7759, US

(73) Assignee: UNIVERSITY OF SURREY, Guildford (GB)

(21) Appl. No.: 12/235,455

(22) Filed: Sep. 22, 2008

(51) Int. Cl. G06N 5/02

(52) U.S. Cl. 706/47

(57) ABSTRACT

One embodiment of the invention provides a method and apparatus for performing service adaptation in respect of a mobile computing device. The method includes providing a service adaptation specification as a set of rules, where each rule comprises a rule body containing one or more premises and a rule head containing one or more conclusions that hold if said one or more premises are true. The rules are defined as classes in an ontology. The premises represent adaptation context and the conclusions represent service adaptation decisions. The method further comprises running the rules on a Description Logics reasoner in conjunction with adaptation context relating to the mobile computing device for a requested service to produce one or more service adaptation decisions. The method further comprises adapting the requested service provided to the mobile computing device in accordance with the service adaptation decisions from the description logics reasoner.

### FIELD OF THE INVENTION

The invention relates to a mobile computing environment, and in particular to an apparatus and method for performing service adaptation in respect of a mobile computing device.

### BACKGROUND OF THE INVENTION

As ubiquitous (pervasive) computing develops, the services and content provided to a user must be adapted to the particular context of the user. The environment of the user may be dynamic and heterogeneous in nature, so that adaptation must cope with complex and volatile situations. Adaptation decisions can be based on the context (description) of relevant entities such as the user, the usage environment, the device(s) involved, the content, the available network(s), etc.

An example of adaptation is where someone has a presentation on a mobile computing device (MCD) and visits a new site to give the presentation. The MCD may want to interact automatically with other devices at the site, e.g. to find out if there is a projection system and/or a sound system available. The MCD might also want to interact with the lighting system in the presentation room to darken the lights during the presentation, as well as with a coffee machine to ensure that hot coffee is available at the end of the talk.

Adaptation decisions are often performed with rule-based systems that use a logic programming paradigm in which a Logic Program (LP) is specified in a rule language and executed by a rule engine. Each rule comprises a rule body (antecedent) containing a set of premises (conditions or if clauses) and a rule head (consequent) containing a set of conclusions or then clauses. The two main languages currently in use for rule-based systems are Prolog and Datalog (which is a subset of Prolog), and well-known existing rule engines are JLog, JBoss Rules, Jess, etc. Examples of rule-based systems for content adaptation are provided in the following papers: Jiang et al, “A Flexible Content Adaptation System using a Rule-based Approach”, IEEE Transactions on Knowledge and Data Engineering, v19, n1, p 127-140, 2007; Stephen and Norman, “Enhancing pervasive Web accessibility with rule-based adaptation strategy”, in Expert Syst. Appl., v32, n4, p 1154-1167, 2007; and Jannach and Leopold, “Knowledge-based multimedia adaptation for ubiquitous multimedia consumption”, Journal of Network and Computer Applications, v30, n3, p 958-982, 2007. Nevertheless, logic programming remains a relatively specialised technology and may not be supported on all devices.

### SUMMARY OF THE INVENTION

One embodiment of the invention provides a method for performing service adaptation in respect of a mobile computing device. The method includes providing a service adaptation specification as a set of rules, each rule comprising a rule body containing one or more premises and a rule head containing one or more conclusions that hold if said one or more premises are true. The rules are defined as classes in an ontology. The premises represent adaptation context, and said conclusions represent service adaptation decisions. The method further includes running the rules on a Description Logics reasoner in conjunction with adaptation context relating to the mobile computing device for a requested service to produce one or more service adaptation decisions. The requested service can then be provided to the mobile computing device in accordance with the service adaptation decisions from the Description Logics reasoner.

In one embodiment, each rule comprises a rule class, a body class and a head class. A body class is made equivalent to a class comprising the one or more premises contained within the rule body, and a head class is made equivalent to a class comprising the one or more conclusions contained within the rule head. Each body class is also made equivalent to the rule class for that rule and each rule class is defined as a subclass of the head class for that rule (conversely, the head class becomes a superclass of the rule class). This allows the head class of the rule to be located when conditions specified in the body class of the rule are satisfied.

In one embodiment, the service adaptation specification uses the OWL ontology language, and may include user preference expressed in OWL. The Description Logics reasoner may comprise an OWL reasoner or any other suitable platform. Note that OWL is becoming very widespread with the development of web 2.0, thereby ensuring that a very large number of devices will provide support for the approach described herein.

In one embodiment, the ontology specifying said rules is kept separate from any ontology that defines concepts in the domain relating to the mobile computing device. This helps performance, since reasoning on the rules ontology is not slowed down by having to also accommodate the terminology from the conventional user/device domain.

In one embodiment, running the rules on a Description Logics reasoner includes loading the rules defined in the ontology and classifying them to model explicit and implicit sub-typing relationships between classes. The loading and classifying may be performed in advance, i.e. prior to receiving any service request, so that the system can respond more quickly when such a service request is received.

In one embodiment, running the rules on a Description Logics reasoner includes extracting context from profiles relating to the requested service and mobile computing device; building classes representing rule bodies; adding the rule body classes to the reasoner; and extracting the rule head classes corresponding to the rule body classes added to the reasoner. Parameters for use in building the rule bodies are calculated by comparing pre-defined functions with uniform values set in the rules ontology (thereby avoiding reclassifying the ontology in response to every request). In addition, the reasoning requests for running on the Description Logics reasoner may be reduced to class requests to help with performance.

Further embodiments of the invention provide a computer program product and a method for implementing such a method.

Another embodiment of the invention provides a method comprising providing a set of rules, each rule comprising a rule body containing one or more premises and a rule head containing one or more conclusions that hold if said one or more premises are true, wherein said rules are defined as classes in an ontology; and running the rules on a Description Logics reasoner in conjunction with reasoning input to produce reasoning output. Such a method can be used in a range of applications relating to a central entity, including service adaptation, automated system diagnostics, and so on.

Another embodiment of the invention provides a method that comprises specifying a set of rules, each rule comprising a rule body containing one or more premises and a rule head containing one or more conclusions that hold if said one or more premises are true; and defining said rules as classes in an ontology, such that the rules can be run on a Description Logics reasoner in conjunction with reasoning input to produce reasoning output. The ontology can then be used to perform service adaptation, automated system diagnostics, etc.

The approach described herein uses Description Logics to sufficiently specify rules that would conventionally be specified in a Logic Program (LP) such as by using Prolog or Datalog rules. The approach can be used in scenarios where reasoning revolves around a central entity, for example a scenario of service adaptation (including content adaptation) as provided to a user who represents the central entity. The approach can also be applied to other scenarios, such as reasoning on customer data, automated problem diagnosis or fault detection in computers or other complex systems, patient diagnosis, and so on.

The approach described herein uses Description Logics outside its conventional remit, in that it uses a DL (ontology) language to specify rules (as a “rules ontology”), and then uses a DL reasoner to run the rules. The rules ontology fulfils the functionalities provided by a Logic Program (e.g. Datalog rules) for the type of scenarios described above. This allows adaptation rules to be specified in in Description Logics, e.g. using OWL 2 (formerly known as OWL 1.1), to provide an ontology that specifies rules rather than domain concepts. The ontology represents rules using the DL constructs of sub-typing and equivalence and can substitute for a Logic Program.

A significant benefit of this approach is that the context community, including multimedia metadata and context modelling in general, is moving in the direction of semantic web context modelling. Thus, in scenarios such as adaptation, the ability to exploit semantic web technologies is highly attractive and allows the approach described herein to be adopted in any system that supports the semantic web. In other words, any system that supports the semantic web will support DL reasoning. Furthermore, off the shelf tools such as OWL development environments and reasoners are available. These tools are generally used by large communities and hence enjoy good support. There is also increasing interest in Description Logics reasoning, including active research into DL reasoning optimisation and expressiveness extensions. These will further enhance the techniques described herein.

It is also possible to make use of DL built-in semantics (disjointness for example) and reasoning services (classification and consistency check). For example, these can handle aspects such as equivalence (ram=rm) and disjointness (video_unable≠deliver_video). In other words, disjointness can be used to ensure that rules can not contain a first class as a premise and the second as a conclusion at the same time. This then allows a consistency check to be performed to ensure the rules are defined consistently (using disjointness, for example). This approach is syntax independent (it depends on DL theory rather than any specific DL language such as OWL), and allows for the structured maintenance, development and extension of rules.

### BRIEF DESCRIPTION OF THE DRAWINGS

Various embodiments of the invention will now be described in detail by way of example only with reference to the following drawings:

FIG. 1 is a schematic diagram representing the arrangement of rules in accordance with one embodiment of the invention.

FIG. 2 is a high-level flowchart depicting a method in accordance with one embodiment of the invention.

FIG. 3 is a schematic diagram showing an example of a system in which the method of FIG. 3 may be utilised in accordance with one embodiment of the invention.

FIG. 4 is a schematic diagram showing a system for implementing the method of FIG. 2 in accordance with one embodiment of the invention.

### DETAILED DESCRIPTION

The relevance and accuracy of service adaptation depends on the amount of available context information. There are several approaches for describing such context. In computer technology, ontologies have been developed to allow the detailed expression of semantic information. Thus an ontology is used to define the permitted items and behaviours of a logical system. The ontology specifies classes, representing the entities in the system, and properties, which define the possible relationships between different classes. As an example, if an ontology is built for the class of people, potential properties include “is a sister of” and “is a brother of”. The ontology may specify that if A is a brother of B, and B is a brother of C, then A is also a brother of C.

Computing ontologies have primarily been developed in the context of Web 2.0 technology, especially using the Web Ontology Language (OWL), which is the emerging standard language for defining and instantiating ontologies. It is hoped that data published on the web will be classified or expressed in conformity with an ontology. In particular, the “semantic web” (Web 2.0) envisages a world in which information is described by a uniform system that provides both formality and universality in terms of syntax and semantics. OWL, Description Logics (DL) and extensible mark-up language (XML) are among the technologies being developed for the semantic web.

Communities working with content (e.g. multimedia) and context are moving towards the use of semantic web multimedia content annotation and semantic-based context modelling. As a result, it is important for a content and service adaptation system to be compatible with the key technologies used in the semantic web. In addition, since new content, device and network technologies emerge rapidly, it is also important that the system is readily extensible to new adaptation scenarios, as well as being flexible, efficient, and relatively easy to maintain.

With the proliferation of the semantic web, the use of Description Logics reasoning has emerged. DL reasoning involves a family of knowledge representation languages based on first order predicate logic and employs a DL language and a DL reasoner. The DL language specifies a domain in terms of concepts (classes) and roles (relationships or properties) among the concepts. DL languages can be used as formalisms to implement ontologies, so that a DL can be regarded as providing a mathematical specification of an ontology. A number of XML and DL based ontology languages have been developed, including OWL. The most recent and expressive version of OWL is OWL v2. In addition, a number of DL reasoners have been developed such as Racer, Pellet and Fact ++ (these can also be regarded as ontology reasoners).

DL reasoners operate differently from rule engines. Depending on the asserted facts, a rule engine fires the appropriate rules in two main methods: forward chaining and backward chaining. Forward chaining is a bottom-up approach where the reasoner starts with a set of conditions to arrive to a certain goal. Backward chaining is a top-down approach where the reasoner starts from a goal and tries to find how to achieve it. In contrast, DL reasoners perform different reasoning tasks such as classification and realization. Classification compares every two concepts (classes) in the ontology to deduce the relationships between them, while realization determines the types (the corresponding classes) to which every individual (instance) in the ontology belongs.

Description Logics reasoning is complex and can be computationally expensive because an update to the ontology requires entire reclassification to maintain consistency. However, current research is investigating various DL reasoning optimization techniques. One possible optimization is incremental reasoning, which allows updates to ontology without triggering an entire reclassification. Incremental reasoning and other optimization techniques have shown some promising results (see Halashek-Wiener et al, “Description Logic Reasoning with Syntactic Updates”, presented at 5^{th} International Conference on Ontologies, Databases and Applications of Semantics, Montpellier, France 2006).

As an example of a conventional ontology in a content and service adaptation scenario, the classes Machine, Device, and Network-enabled-device may be specified, where the class Network-enabled-device is defined as a subclass of Device. Other concepts in this domain might be User, Content, Environment, etc., with relationships then being defined such as hasDevice(User, Device), hasUser(Environment, User), and so on. According to the current context, instances are built, corresponding for example to the N70 and N95 (two mobile telephones from Nokia) and to the Dell 2532. The types of these instances are obtained, such as network-enabled-device, and this is then used to make certain decisions about the provision of services to the relevant devices.

This use of Description Logics and ontologies can be considered as the “traditional” use of OWL—i.e. using DL (ontologies) to classify types and to define their instances. In contrast, the present approach as described in more detail below involves using an ontology and Description Logics to define rules for service adaptation.

### Defining Rules in the Rules Ontology

A rule is of the form (RuleBody→RuleHead). A RuleBody is a set of premises and a RuleHead is a set of conclusions that follow from the premises. The present approach specifies rules using the following Description Logics (DL) constructs: class sub-typing (⊂), class equivalence (≡), intersection (∩) and union (∪), and by creating three classes, namely the Rule, the RuleBody and the RuleHead classes. These classes are subclasses of the top concept ⊥, to which all concepts are either a direct or an indirect subclass:
Rule⊂⊥
RuleBody⊂⊥
RuleHead⊂⊥
   To add a rule, a class that represents the rule (Rule_n) is created as a direct subclass of the Rule class. The n in Rule_n is an identifier that is unique to each rule:
Rule_n⊂Rule

Each rule (for example Rule_{—}1, Rule_{—}2 . . . etc) has a rule body and a rule head represented by a Body_n class and a Head_n class respectively. Body_n and Head_n are subclasses of the classes RuleBody and RuleHead respectively. Body_n is asserted equivalent to its respective Rule_n. As a result, if the premises in the Body_n hold true, it is known which rule to invoke by extracting the equivalent class of Body_n. Head_n is asserted as a super type of its respective Rule_n and thus it is a super type of its respective Body_n (because Body_n is equivalent to Rule_n).
Body_n⊂RuleBody
Rule_n≡Body_n
Head_n⊂RuleHead
Rule_n⊂Head_n

The motivation for defining these relationships between Rule_n, Body_n and Head_n will now be explained. Sub-typing is defined as:

A⊂B [symbol] ∀x x ∈ A [symbol] x ∈ B

(i.e. A is a sub-type of B if every element x of A is also an element of B). For x to be part of A it has to match all A element characteristics. Similarly, for x to be part of B it has to match all B element characteristics.

There is a parallel here between sub-typing (and the hence super-typing in the opposite direction) and the operation of rules. In particular, if a set of premises described in a rule body is found to hold true (analogous to x ∈ A ), then it is implied [symbol] that the set of conclusions defined in the rule head also holds true (analogous to x ∈ B).

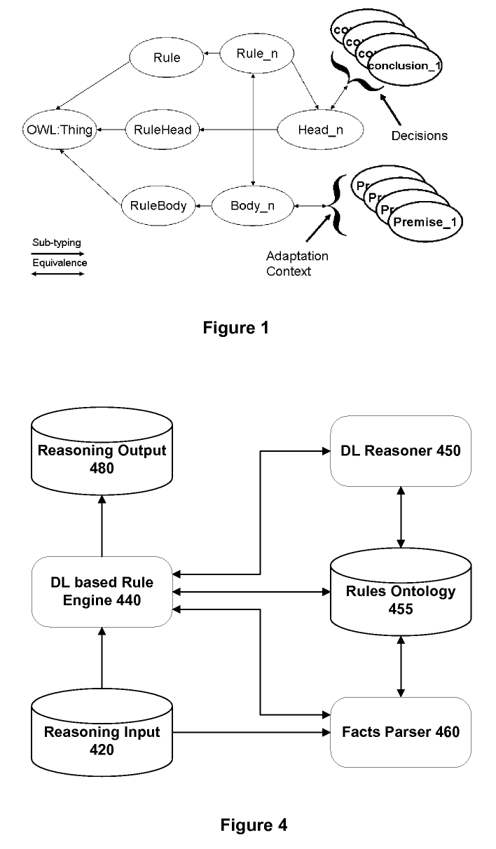

The above configuration is illustrated in FIG. 1, which depicts the classes Rule, RuleHead and RuleBody (these are all sub-types of the general OWL class Thing). The class for each particular rule, Rule_n, is a sub-type of the class Rule. Similarly, the class for each particular rule body, Body_n, is a sub-type of the class RuleBody, and the class for each particular rule head, Head_n, is a sub-type of the class RuleHead.

As shown in FIG. 1, each rule body comprises a set of one or more premises that reflects the adaptation context, while each rule head comprises a set of one or more corresponding conclusions that represents adaptation decisions. Note that the individual premises and conclusions are also classes, with the Body_n class being made equivalent to a premise class which is formed from a combination of one or more premises. Likewise, the Head_n class is made equivalent to a conclusion class formed from the combination of one or more conclusions. A premise class is regarded as simple if it represents a single condition, while a complex premise is based on the combination of multiple premises (simple or complex) joined together using AND (intersection) and/or OR (union) operators.

FIG. 1 further illustrates that the body of a particular rule, Body_n, is made equivalent to the corresponding rule, Rule_n, which in turn is a subclass of the corresponding rule head, Head_n. This implies that Body_n is also a subclass of Head_n (since Body_n is equivalent to Rule_n). An element of Body_n is therefore necessarily also an element of Head_n. In other words, if the context makes the premises of Body_n true, then the conclusions of Head_n are also true.

The unique identifier n for each rule body and its corresponding rule head is used to distinguish them from the body/head of other rules. Each rule body/head can be represented as follows:

Body_n≡{premise_{—}1 ∩|∪ premise_{—}2}*∩|∪ {premise_{—}3 ∩|∪ premise_n}*

Head_n≡{conclusion_{—}1 ∩ conclusion_{—}2 ∩ . . . ∩ conclusion_n}

Each conclusion or premise is either a named class or an unnamed class:

premise_n≡namedClass|anonymousClass

conclusion_n≡namedClass|anonymousClass

A named class is a class definition that has been assigned a name, for example

battery_limited≡∃ battery_limitation<x

In this case, the class definition ∃ battery_limitation<x is given the name battery_limited and is defined as: there exists (∃) a battery_limitation data property relationship that has a range of values smaller than some value x. If the definition is not given the name battery_limited, then it remains as an anonymous or unnamed class.

The naming of a conclusion or a premise is optional. The allocation of a name is generally done to make it easier to re-use the premise or conclusion, for example as part of another premise/conclusion (whether in the same or a different rule body or head). The ability to refer to the premise/conclusion by name avoids having to duplicate the entire premise/conclusion itself. Note that if the set of possible premises and conclusions (representing conditions in the user context and adaptation decisions respectively) is very large it may be impractical to name all premises and conclusions. In this case, a premise or conclusion would be named if its definition is lengthy, complex and likely to be re-used.

An example of a named class which provides an illustration of how context can be specified as one or more premises in rule bodies is:

$$remove\_video \_condition ≡ \{ \begin{matrix}∃ user\_requires ( Summary ) ⋂ \\ ∃ prefered\_modality \_I ( image )\end{matrix} \} ⋃ \{ \begin{matrix}∃ device\_limitation \\ ( video\_incapable )\end{matrix} \} ⋃ \{ \begin{matrix}∃ battery\_limitation < 0.2 ⋂ \\ ∃ prefered\_modality \_I ( video )\end{matrix} \}$$

The named class remove_video_condition can be regarded as a complex premise formed from three simple premises, each corresponding to one particular situation—the user requires a summary; a device does not support video; and there is a limited remaining battery life. Each of these (simple) premises may lead to the same outcome: a decision to remove video content. Naming this class saves the effort of having to (re)type its definition each time it is included in the complex premise of a rule body. The usage of named and un-named classes applies to conclusions in the same way as it does to premises.

User preferences may be specified with class definitions of the form:

∃ user_prefers (some_preference)

According to this definition, there exists a user_prefers object property relationship that has the value some_preference, where some_preference is an instance (or individual) in the ontology. All user preferences are defined as instances in the ontology. A premise that describes a user preference is formed by asserting the respective preference with the object property user_prefers. A similar approach can be used to specify device, network and environment context, for example:

∃ has_device_property (some_property)

where has_device_property is an object relationship and some_property is an instance in the ontology.

In some cases, the priority or ordering of some preference needs to be specified. For example, the priority of preferred modalities which can be specified as follows:

∃ Prefers_modaity_{—}1 (video) ∩ ∃ Prefers_modality_{—}2(audio) ∩ ∃ Prefers_modality_{—}3(text)

In this example, Prefers_modality_n is an object property, n is the order of preference or priority (0≦n≦4), and video, audio and text are instances in the ontology. The above class definition means that the user's first preferred modality is video, then audio and then text.

Note that in this example, a data property could be used instead of an object property to define a premise. For example, Prefers_modality_n could be modelled as a Datatype property where video, audio and text represent string values. Reasoning involving data types is used for user preferences or other context elements that involve the comparison of data types.

As an example, consider a facility for 2D to 3D Stereoscopic Conversion. This might involve the following MPEG-21-DIA data type properties: ParallaxType (negative, positive); DepthRange (zeroToOne); MaxDelayFrame(nonNegativeInteger). Within this facility, preference might be specified as follows:

∃ 2D_{—}3D_stereoscopic_Parallax_type (positive|negative)

∃ 2D_{—}3D_stereoscopic_Depth_range≧|≦|=x (0≦x≦1)

∃ 2D_{—}3D_stereoscopic_Max_delay_frame≧|≦|=x (x≧0)

In some cases, user preferences or other context elements may have dynamic values and two or more parameters need to be compared. For example, the available battery resource (a), the remaining resource preferred by the user (u), and the resource required by the service(r). Such cases can be modelled by creating a data property (e.g. battery_limitation) and adding the following class definition to relevant rule bodies:

∃ Battery_limitation≧|≦|=x

where x=(a−r)/u. For example, x ((a−r)/u)≦1 entails adapting by reducing (|a−r−u/r|*100) % of the service battery resource requirement; e.g. if a=60, r=40, u=30, then (a−r)/u=0.66, so that the battery requirement should be reduced by |60−40−30/40*100%=25%. Such predefined functions (e.g. a−r/u) are used to avoid changing the ontology for each request and hence to avoid reclassification (this helps to eliminate a considerable overhead). In other words, rather than determining (for example) Required_resource>x, where x is the available resource and is changed for each request (thereby requiring reclassification and hence a changed ontology for each request), the predefined function a-r/u is compared to a normative value (in this case 1). (As noted above, it is possible that optimizations of general DL techniques such as incremental reasoning may also help this issue in the future).

Note that Description Logics languages are monotonic. This means that the addition of assertions never invalidates any previously inferred knowledge. Monotonic logic requires the Open World Assumption (OWA), where OWA (as opposed to Negation as Failure (NF)) implies that the absence of some information does not negate it. The OWA model is difficult to reconcile with common adaptation scenarios. For example, if mp4 is not present in the supported formats list of a device profile, it should generally be assumed that mp4 is not supported.

This issue is addressed by using the construct of object property negation as recently implemented in OWL 2. For example, if a device does not have mp4 in its supported formats list, the following is asserted:

[symbol]

(∃supports_format(mp4))

where [symbol] denotes the negation symbol, supports_format is an object property, and mp4 is an instance in the ontology. The class mp4-limited can then be described as:

mp4_limited≡ [symbol] {∃supports_format(mp4)}∩{∃required_format(mp4)}

In other words, a device is regarded as mp4 limited if mp4 is a required format but mp4 is not specifically listed as a supported format for the device.

In the content and service adaptation scenario, conclusions (that constitute rule heads) represent adaptation decisions that need to be applied to the content or service. These decisions are specified as follows:

∃ decision_n (someDecision)

where decision_n is an object property and someDecision is an instance in the ontology. The identifier n is the order in which the decision should be applied. In some cases several decisions can be applied to satisfy a certain decision aim. For example, to satisfy the decision aim of reducing the memory requirements of a service, the decisions which could potentially be applied might include reducing temporal or spatial resolution and removing certain content etc. In this case, the decision aims can be modelled as follows:

∃ decision_aim_n.someDecisionAim

where decision_aim_n is an object property, n is the order in which the decision aim is to be satisfied and someDecisionAim is a class in the rules ontology that has instances representing decisions that satisfy the decision aim (someDecisionAim). Such instances might be attributed to more than one someDecisionAim class as one decision might satisfy more than one decision aim.
Running the Rules with a DL Reasoner

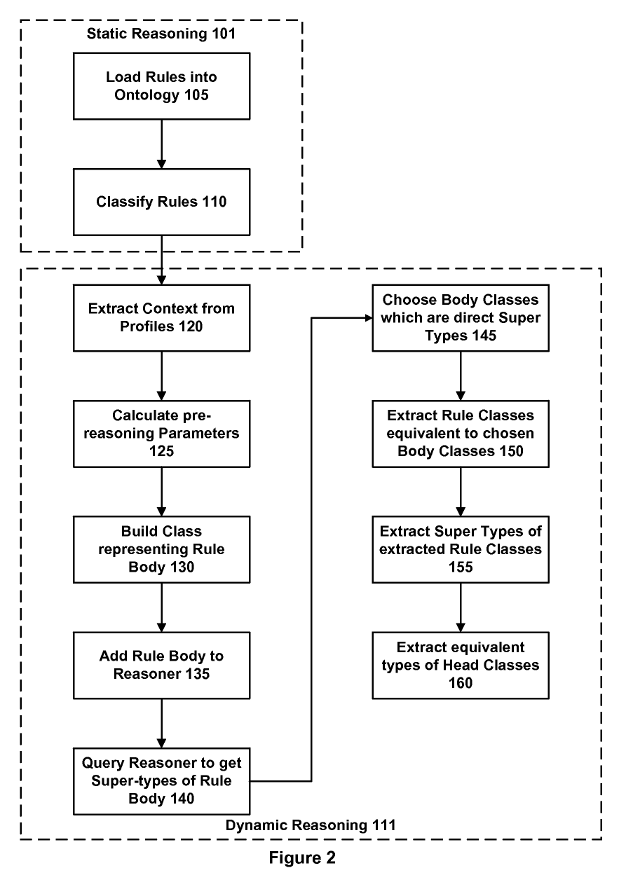

FIG. 2 depicts how the rules defined in the rules ontology (as per section 1 above) are used by a DL reasoner. Reasoning with the rules ontology is performed in the following steps:

Static Reasoning 101 (Rules Ontology Classification)
1. At start-up, the reasoner loads the rules defined in the ontology (operation 105) and classifies them (operation 110) before receiving any requests. The rules are thereby organized into a hierarchy that models explicit as well as implicit sub-typing relationships between them. This static reasoning helps to improve performance, in that the relevant processing has already been performed before any requests are received (and hence does not contribute to the response time for requests).

Dynamic Reasoning 111 (Running the Rules Upon Receiving Requests)
2. Extract context from profiles (operation 120).
3. Calculate pre-reasoning parameters using pre-defined functions (operation 125). These functions are used to compare parameters without having to change the rules ontology (and thereby avoiding reclassification) by allowing the result of the pre-reasoning functions to be compared with uniform values set in the rules ontology. An example of this would be evaluating whether x−y<0 is true or false (instead of evaluating whether x<y is true or false).
4. Build a class representing a rule body (tempRuleBody) (operation 130).
5. Add the rule body class (tempRuleBody) to the reasoner (operation 135).
6. Invoke the reasoner to get (query) the types and super-types of tempRuleBody (which would be one or more of the Body n classes) (operation 140).
7. Choose the Body_n classes found in operation 140 that are direct super types of tempRuleBody (the direct super types represent the most specific rules which apply) (operation 145).
8. Extract the equivalent classes to the chosen Body_n classes (which would be the Rule_n classes) (operation 150).
9. Extract the super types of the Rule_n classes extracted form step 8 (which would be the Head_n classes) (operation 155).
10. Extract the equivalent classes to the Head_n classes extracted in step 9 (which represent the adaptation decisions in this scenario) (operation 155).

Note that steps 8 and 9 could be combined into a single step in which the extracted super types are those of the Body_n classes rather than of the Rule_n classes (the end result is the same since Body_n is equivalent to Rule_n).

In the above approach, all reasoning requests are reduced to class requests. This approach reflects the fact that instances reasoning is generally less effective than class reasoning (see for example: L. Lei and H. Ian, “A software framework for matchmaking based on semantic web technology” in Proceedings of the 12th international conference on World Wide Web. Budapest, Hungary: ACM, 2003).

Furthermore, in the above approach, the terminology ontology is separate from the rules ontology (and vice versa). In other words, the rules ontology does not import or use concepts defined in the terminology ontology (the terminology ontology is the ontology that defines the concepts in the relevant domain, for example, user, device, preference, content . . . etc). This logical separation of the rules ontology from the terminology ontology avoids having to import all the concepts from the latter into the former, which would then involve the reasoner having to classify a larger and more complex ontology (and hence degrade performance).

In order to understand the difference between a terminology ontology and a rules ontology, consider the “uncle” problem in OWL. It is well-known that in a conventional ontology, OWL cannot express the fact that if A is the brother of B, who is the father of person C, then person A is also the uncle of person C. However, in a rules ontology such as described here we can write this as:

father_of(b, c) and brother_of(a, b)→uncle_of(a, c)

(the syntax adopted will vary according to the particular domain involved).

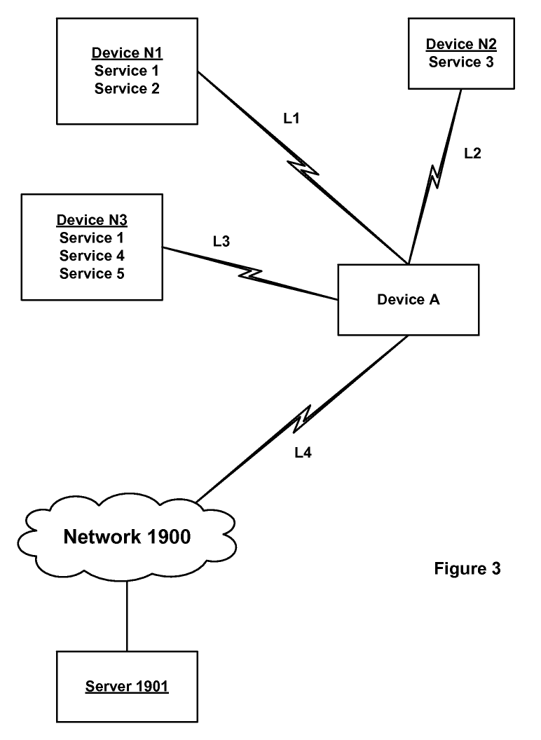

FIG. 3 illustrates a pervasive computing environment in which the above approach may be implemented. The environment includes Device A which might represent, for example, a mobile telephone, a portable or handheld computing device, a portable music or video player, a GPS navigation unit, some device that provides some combination of such functionality, or any other suitable device. Furthermore, device A might be intrinsically portable (such as for a mobile telephone) or somehow incorporated into a moving or movable system, such as a motor car. Device A might also represent a device such as a digital television that normally remains in one place, but which may need to discover and then interact with a potentially variable set of devices in its immediate locality, such as set-top box, hard disk recorder, etc.

Device A uses wireless link L1 to contact device N1, which offers services 1 and 2, wireless link L2 to contact device N2, which offers service 3, and wireless link L3 to contact device N3, which offers services 1, 4 and 5. Note that Devices N1-N3 may be fixed, or may themselves be mobile computing devices, perhaps temporarily in the same environment as Device A. Device A can also access server 1901 via wireless link L4 and network 1900 (also potentially via one or more devices, not shown in FIG. 3). This allows any content on server 1901 to be retrieved by Device A.

The content or other services provided to Device A are dependent on parameters such as the environment of Device A (e.g. whether or not devices N1, N2 and N3 are present), the network link L4 to device A, the hardware and software support available in Device A, the preferences of the user of Device A, and so on. These parameters determine the context which is then used for making the adaptation decisions regarding the content or services. (Since the supply of content can be regarded as a service, adaptation of the content is generally considered as a service adaptation herein).

FIG. 4 is a schematic illustration of a system for making such adaptation decisions in accordance with one embodiment of the invention. As shown in FIG. 4, the system receives input data 420 which determines the relevant context in the form of facts. This context is passed to the DL-based rule engine 440. The facts may be specified in the form of an ontology, and may be passed to the rule engine 440 via a facts parser 460 which converts the facts into a suitable form for use by the rule engine. The rule engine 440 generates reasoning output 480, which corresponds to the adaptation decisions. The production of this output is based on applying DL reasoning by a DL reasoner 450 to the rules ontology 455, having regard to the input facts 420. Output production may also involve further processing of the adaptation decisions, for example transforming them into an appropriate format (this further processing may be performed by the rule engine 440 or some other appropriate component). The system of FIG. 4 may be implemented for example on server 1901 as shown in FIG. 3 for making adaptation decisions in relating to the provision of content or other services to a device.

In conclusion, various embodiments of the invention have been described by way of example only, and having regard to particular environments and application requirements. For example, although the rules ontology has been presented in the context of making adaptation decisions regarding the provision of services in a mobile computing context, it can be used in other environments. One possibility is to use the rule ontology in a diagnostic system for a computer or other device. In this case the reasoning input represents reports about the status of the machine (from programs, sensors, etc), and the output represents a diagnosis of the status of the machine—e.g. if a particular combination of errors is observed, this might signal a problem with a certain hardware device. Accordingly, the person of ordinary skill in the art will appreciate that many variations may be made to the particular implementations described herein without departing from the spirit and scope of the invention as defined by the appended claims.

What is claimed is:

1. A method for performing service adaptation in respect of a mobile computing device comprising:
providing a service adaptation specification as a set of rules, each rule comprising a rule body containing one or more premises and a rule head containing one or more conclusions that hold if said one or more premises are true, wherein said rules are defined as classes in an ontology, said premises represent adaptation context, and said conclusions represent service adaptation decisions;
running the rules on a Description Logics reasoner in conjunction with adaptation context relating to the mobile computing device for a requested service to produce one or more service adaptation decisions; and
adapting the requested service provided to the mobile computing device in accordance with the service adaptation decisions from the Description Logics reasoner.

2. The method of claim 1 wherein each rule comprises a rule class, a body class and a head class.

3. The method of claim 2, wherein a body class is made equivalent to a class comprising the one or more premises contained within the rule body.

4. The method of claim 2, wherein a head class is made equivalent to a class comprising the one or more conclusions contained within the rule head.

5. The method of claim 2, wherein each body class is made equivalent to the rule class for that rule.

6. The method of claim 5, wherein each rule class is defined as a subclass of the head class for that rule.

7. The method of claim 1 wherein said service adaptation specification uses the OWL ontology language.

8. The method of claim 7, wherein said service adaptation specification includes user preferences expressed in OWL.

9. The method of claim 1, wherein said Description Logics reasoner comprises an OWL reasoner.

10. The method of claim 1, wherein the ontology specifying said rules is separate from any ontology that defines concepts in the domain relating to the mobile computing device.

11. The method of claim 1, wherein running the rules on a Description Logics reasoner includes loading the rules defined in the ontology and classifying them to model explicit and implicit sub-typing relationships between classes.

12. The method of claim 11, wherein said loading and classifying are performed prior to receiving any service request.

13. The method of claim 1, wherein running the rules on a Description Logics reasoner includes:
extracting context from profiles relating to the requested service and mobile computing device;
building classes representing rule bodies;
adding the rule body classes to the reasoner; and
extracting the rule head classes corresponding to the rule body classes added to the reasoner.

14. The method of claim 13, further comprising calculating parameters for use in building the rule bodies by comparing pre-defined functions with uniform values set in the rules ontology.

15. The method of claim 1, further comprising reducing reasoning requests for running on the Description Logics reasoner to class requests.

16. A computer program product comprising machine-readable instructions for implementing a method for performing service adaptation in respect of a mobile computing device comprising:
providing a service adaptation specification as a set of rules, each rule comprising a rule body containing one or more premises and a rule head containing one or more conclusions that hold if said one or more premises are true, wherein said rules are defined as classes in an ontology, said premises represent adaptation context, and said conclusions represent service adaptation decisions;
running the rules on a Description Logics reasoner in conjunction with adaptation context relating to the mobile computing device for a requested service to produce one or more service adaptation decisions; and
adapting the requested service provided to the mobile computing device in accordance with the service adaptation decisions from the Description Logics reasoner.

17. Apparatus configured to perform service adaptation in respect of a mobile computing device, said apparatus comprising:
a set of rules comprising a service adaptation, each rule comprising a rule body containing one or more premises and a rule head containing one or more conclusions that hold if said one or more premises are true, wherein said rules are defined as classes in an ontology, said premises represent adaptation context, and said conclusions represent service adaptation decisions; and
a Description Logics reasoner for running the rules in conjunction with adaptation context relating to the mobile computing device for a requested service to produce one or more service adaptation decisions;
wherein the requested service provided to the mobile computing device may be adapted in accordance with the service adaptation decisions from the Description Logics reasoner.

18. A method comprising providing a set of rules, each rule comprising a rule body containing one or more premises and a rule head containing one or more conclusions that hold if said one or more premises are true, wherein said rules are defined as classes in an ontology; and running the rules on a Description Logics reasoner in conjunction with reasoning input to produce reasoning output.

19. The method of claim 18, wherein said method is used to perform automated system diagnostics.

20. A method comprising specifying a set of rules, each rule comprising a rule body containing one or more premises and a rule head containing one or more conclusions that hold if said one or more premises are true; and defining said rules as classes in an ontology, such that the rules can be run on a Description Logics reasoner in conjunction with reasoning input to produce reasoning output.
